(19) United States
(12) Patent Application Publication
(10) Pub. No.: US 2005/0098594 A1
(43) Pub. Date: May 12, 2005

(54) Carrying case for a DVD player

(76) Inventor: Peggy Truong, Newark, NJ (US)

Correspondence Address: EZRA SUTTON, PA, PLAZA 9, 900 ROUTE 9, WOODBRIDGE, NJ, 07095, US

(21) Appl. No.: 10/706,758

(22) Filed: Nov. 12, 2003

(51) Int. Cl. B60R 7/00

(52) U.S. Cl. 224/275

(57) ABSTRACT

A carrying case for securing a telecommunication device to a seat within a vehicle. The carrying case includes a housing member having a first inner storage compartment and a second inner storage compartment. The first inner storage compartment has walls for forming an interior storage space (34) for receiving and holding a telecommunication device therein. The second inner storage compartment has walls for forming an interior storage space (94) therein. The carrying case further includes a connecting zipper member for detachably connecting the first inner storage compartment and the second inner storage compartment with each other and for receiving and displaying a telecommunication device within the first inner storage compartment. The carrying case also includes a hinge assembly having a hinge attachment strip member and a hinge attachment flap member for detachably connecting the first inner storage compartment to the second inner storage compartment. The hinge attachment flap member of the hinge assembly is detachable from the hinge attachment strip member and the hinge attachment flap member is reversible for moving the hinge attachment flap member from a first attachment position having the housing member in a closed configuration to a second attachment position having the housing member in an opened and assembled configuration.

### FIELD OF THE INVENTION

The present invention relates to a DVD player carrying case for receiving a DVD unit therein and the carrying case is used on the backside of a front seat of a moving vehicle such as a car, van, sports utility vehicle (SUV), jeep, limousine and the like. More particularly, the DVD player carrying case includes a plurality of detachable holding straps being attachable to one of the front seats in order to secure the DVD unit and DVD player carrying case to the backside of one of the front seats of the passenger vehicle.

### BACKGROUND OF THE INVENTION

DVD viewing for backseat passengers traveling in moving vehicles has been found to be useful to a broad range of travelers from busy executives who maintain a chauffeured driven limousine to children and adults on family trips and vacation. Telecommunication transportation equipment and apparatus existing presently suffer from several problems with regard to ease and portability of use, as well as protection of the transported equipment such as a DVD player unit. These problems include deficiencies in equipment size, modularity, water resistant integrity, internal and external structural support, remote power supply capability, user and equipment access, storage capacity, and design compatibility with the vehicle, all of which are addressed and overcome by the present invention.

Therefore there remains a need for a removable DVD player carrying case for receiving a DVD unit therein for placement on the backside of a front seat within a moving vehicle, as well as a harness strapping system for mounting of the DVD player carrying case to one of the front seats of the passenger vehicle. Additionally, the DVD carrying case needs to be of a two part construction having a fnst inner storage compartment and a second inner storage compartment interfacing with each other for increased internal and external structural support for housing the DVD player unit within the inner storage compartment.

### DESCRIPTION OF PRIOR ART

Telecommunication transportation equipment, telecommunication transport apparatus and devices, television support devices having various designs, configurations, structures and materials of construction have been disclosed in the prior art. For example, U.S. Pat. No. 4,585,196 to CORMIER discloses a television support apparatus for use on an automobile front seat or center armrest utilized for rear seat viewing. The frame is generally U-shaped to fit over the back rest of the front seat or center armrest and is secured to the seat or center armrest by straps which are tightened around the seat or armrest. The portable television is secured to the frame by channel members which receive the base of the television and also by a strap which is tightened around the frame and television. This prior art patent does not teach or disclose the structure and design of the present invention of a DVD player carrying case having first and second interfacing inner storage compartments for supporting and receiving of a DVD unit therein.

U.S. Pat. No. 5,725,189 to LANDY discloses an electronic device support apparatus including a wedge-shaped stand portion of light-weight material to support an electronic device. The support apparatus supports any type of electronic device, including a television set, a VCR, both a television and a VCR, any video monitor, a stereo, etc. The support apparatus is light-weight and portable and particularly suited to support an electronic device in an automobile. The apparatus includes a support strap coupled to the stand and adapted to surround the exterior of the electronic device. The support strap includes a closure means for retaining the support strap at a location adjacent to the exterior of the electronic device. This prior art patent does not teach or disclose the structure and design of the present invention of a DVD player carrying case having first and second interfacing inner storage compartments for supporting and receiving of a DVD unit therein.

U.S. Pat. No. 6,092,705 to MERIT discloses a self-contained mounting system (a case) for housing, transporting and mounting video equipment (TV monitor, video player and the like) for use in passenger vehicles. The mounting system is releasably and securely mounted as an entertainment accessory within an automobile. The automobile has first and second headrests extending from at least one seat and an internal floor. The mounting system comprises a first case for receiving the entertainment accessory and a first quick connect device for releasably securing the first case to the internal floor and at least one of the first and second headrests. This prior art patent does not teach or disclose the structure and design of the present invention of a DVD player carrying case having first and second interfacing inner storage compartments for supporting and receiving of a DVD unit therein.

U.S. Pat. No. 6,473,315 to DENMEADE discloses a telecommunications equipment transportation apparatus for remotely transporting telecommunications equipment for portable use, and in particular to an apparatus for transportation of such equipment for use away from the home or office. The telecommunications equipment transportation apparatus includes a base section, a container section and a harness system. The base provides a suspension which forms the supporting foundation for the unit and the equipment stored therein, and houses a power circuit that includes electrical outlet(s) for providing battery or generator-supplied alternating current (AC) or direct current (DC) power to the transported telecommunications equipment. This prior art patent does not teach or disclose the structure and design of the present invention of a DVD player carrying case having first and second interfacing inner storage compartments for supporting and receiving of a DVD unit therein.

None of the aforementioned prior art patents teach or disclose the structure, design and configuration of the present invention of DVD player carrying case having first and second interfacing inner storage compartments for supporting and receiving of a DVD unit therein, as well as a harness strapping system for mounting of the DVD player carrying case to one of the front seats of a passenger vehicle.

Accordingly, it is an object of the present invention to provide a DVD player carrying case that gives the user a unique and novel carrying and fastening system being especially designed for transporting telecommunication equipment for portable use and to a remote location. In particular, the present invention provides for an apparatus for transport of such devices that include but are not limited to DVD devices, televisions (TV's), combined TV and DVD units, television video cassette recorder (VCR) units, computer monitors and equipment, and video telephones, etc. for use both separately or in combination with each other and with other peripheral and accessory equipment.

Another object of the present invention is to provide a DVD player carrying case for the transport of portable telecommunications equipment for use away from the home or office.

Another object of the present invention is to provide a DVD player carrying case being designed and constructed to protect, organize, fasten and strap the DVD unit during transportation and use.

Another object of the present invention is to provide a DVD player carrying case that is easily fastened and strapped to one of the front seats of a moving vehicle and firmly positioned and secured on the backside of one of the front seats of the vehicle in order to minimize vibration for viewing the DVD unit by passengers seated in the rear seats of the moving vehicle.

Another object of the present invention is to provide a DVD player carrying case that can be designed and configured for use in moving vehicles such as automobiles, jeeps, minivans, vans, sport utility vehicles, recreational vehicles, campers, limos, boats, recreational aircraft and the like.

Another object of the present invention is to provide a DVD player carrying case that enables the users to safely bring along such fragile telecommunication equipment (i.e, DVD monitors) for use in a variety of remote settings.

Another object of the present invention is to provide a DVD player carrying case that is of a two part construction having a first inner storage compartment and a second inner storage compartment interfaced with each other for increased internal and external structural support for housing of the DVD unit therein.

Another object of the present invention is to provide a DVD player carrying case that incorporates a unique and improved construction and design in terms of size, modularity, materials, water resistant integrity, internal and external structural support, remote power supply capability, user and equipment access, storage capacity, and design compatibility with the transportation medium such as a vehicle and/or platform configuration of the vehicle in order to overcome the problems posed by the prior art.

A further object of the present invention is to provide a DVD player carrying case that is capable of withstanding everyday wear and tear, as well as being secure, safe, efficient, durable and easy to use.

A still further object of the present invention is to provide a DVD player carrying case that can be mass produced in an automated and economical manner and is readily affordable by the consumer.

### SUMMARY OF THE INVENTION

In accordance with the present invention, there is provided a carrying case for securing a telecommunication device to a seat within a vehicle. The carrying case includes a housing member having a first inner storage compartment and a second inner storage compartment. The first inner storage compartment has walls for forming an interior storage space (34) for receiving and holding a telecommunication device therein. The second inner storage compartment has walls for forming an interior storage space (94) therein. The carrying case further includes a connecting zipper member for detachably connecting the first inner storage compartment and the second inner storage compartment with each other and for receiving and displaying a telecommunication device within the first inner storage compartment. The carrying case also includes a hinge assembly having a hinge attachment strip member and a hinge attachment flap member for detachably connecting the first inner storage compartment to the second inner storage compartment. The hinge attachment flap member of the hinge assembly is detachable from the hinge attachment strip member and is reversible for moving the hinge attachment flap member from a first position for having the housing member in a closed configuration to a second position for having the housing member in an opened and assembled configuration. Additionally, the carrying case includes a harness strapping assembly having a pair of detachable straps for connecting to a seat of a vehicle; and one of said detachable straps having at its outer ends releasable latch members, respectively, for releasably attaching to strap connecting hooks of the first inner storage compartment.

### BRIEF DESCRIPTION OF DRAWINGS

Further objects, features, and advantages of the present invention will become apparent upon the consideration of the following detailed description of the presently-preferred embodiment when taken in conjunction with the accompanying drawings, wherein:

FIG. 1 is a front perspective view of the DVD player carrying case of the preferred embodiment of the present invention showing the DVD carrying case having a DVD unit therein in an assembled state being readied for operational use thereof:

FIG. 2 is a front perspective view of the DVD player carrying case of the preferred embodiment of the present invention showing the DVD player carrying case having the DVD unit therein for attachment to the headrest and backrest of the driver's front seat being in an assembled state and in operational use thereof;

FIG. 3 is an exploded perspective view of the DVD player carrying case of the present invention showing the DVD unit being received within a first inner storage compartment and the first inner storage compartment interfacing with a second inner storage compartment;

FIG. 4 is a rear perspective view of the DVD player carrying case of the present invention showing an upper storage pouch with a closure flap, a lower DVD storage sleeve, a harness strapping assembly and the first and second inner storage compartments;

FIG. 5 is an exploded rear perspective view of the DVD player carrying case of the present invention showing the operational use of the upper storage panel and the lower DVD storage sleeve in an assembled configuration;

FIG. 6 is a perspective view of te DVD player carrying case of the present invention showing the first inner storage compartment detachably removable from the second inner storage compartment;

FIG. 7 is a rear perspective view of the DVD player carrying case of the present invention showing a hinge assembly for connecting the first and second inner storage compartments together;

FIG. 8 is a side perspective view of the DVD player carrying case of the present invention showing a hinge attachment flap member is an opened state being connected to the hinge attachment strip member of the hinge assembly on the first inner storage compartment when in the closed position;

FIG. 9 is a side perspective view of the DVD player carrying case of the present invention showing the hinge attachment flap member of the hinge assembly attached to the first inner storage compartment when in the closed position;

FIG. 10 is an exploded perspective view of the DVD player carrying case of the present invention showing the interfacing of the first inner storage compartment with the second inner storage compartment;

FIG. 11 is a bottom perspective view of the DVD player carrying case of the present invention showing a zipper member closing the first and second inner storage compartments together;

FIG. 12 is a perspective view of the DVD player carrying case of the present invention showing a headrest detachable attachment strap for attaching and holding to the passenger's headrest and a backrest harness detachable strap for attaching and holding to the passenger's front seat of the passenger vehicle being readied to attach the DVD player carrying case thereto;

FIG. 13 is a cross-sectional view of the DVD player carrying case of the present invention taken along lines 13-13 of FIG. 5 in the direction of the arrows showing the upper storage pouch and closure flap, the upper mesh storage pouch, the first and second inner storage compartments, the hinge assembly and the zipper member in an opened and assembled configuration;

FIG. 14 is a cross-sectional view of the DVD player carrying case of the present invention taken along lines 14-14 of FIG. 5 in the direction of the arrows showing the disc storage sleeve member, the lower mesh storage member, the lower mesh storage pouch, the first and second inner storage compartments, the hinge assembly and the zipper member in an opened and assembled configuration;

FIG. 15 is a cross-sectional view of the DVD player carrying case of the present invention taken along lines 15-15 of FIG. 5 in the direction of the arrows showing the major component parts thereof in an opened and assembled configuration;

FIG. 16 is a cross-sectional view of the DVD player carrying case of the present invention taken along lines 16-16 of FIG. 9 in the direction of the arrows showing the hinge assembly, the first and second storage compartments and the zipper member in a closed and unassembled configuration; and

FIG. 17 is a cross-sectional view of the DVD player carrying case of the present invention taken along lines 17-17 of FIG. 9 in the direction of the arrows showing the handle member, the first and second storage compartments and the zipper member in a closed and unassembled configuration.

### DETAILED DESCRIPTION OF THIS PREFERRED EMBODIMENT

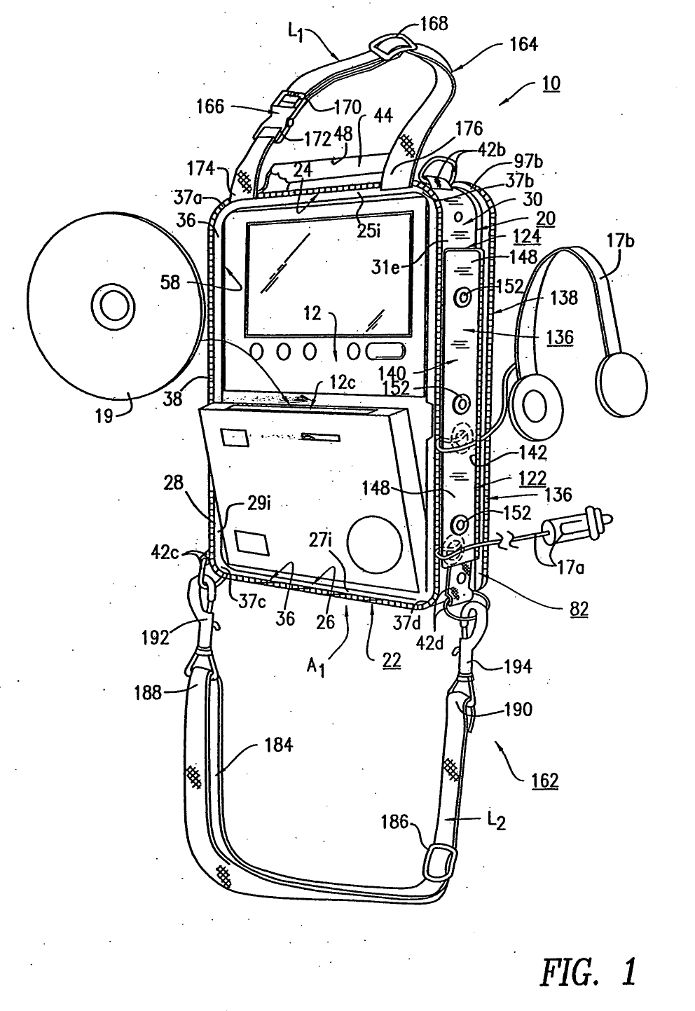

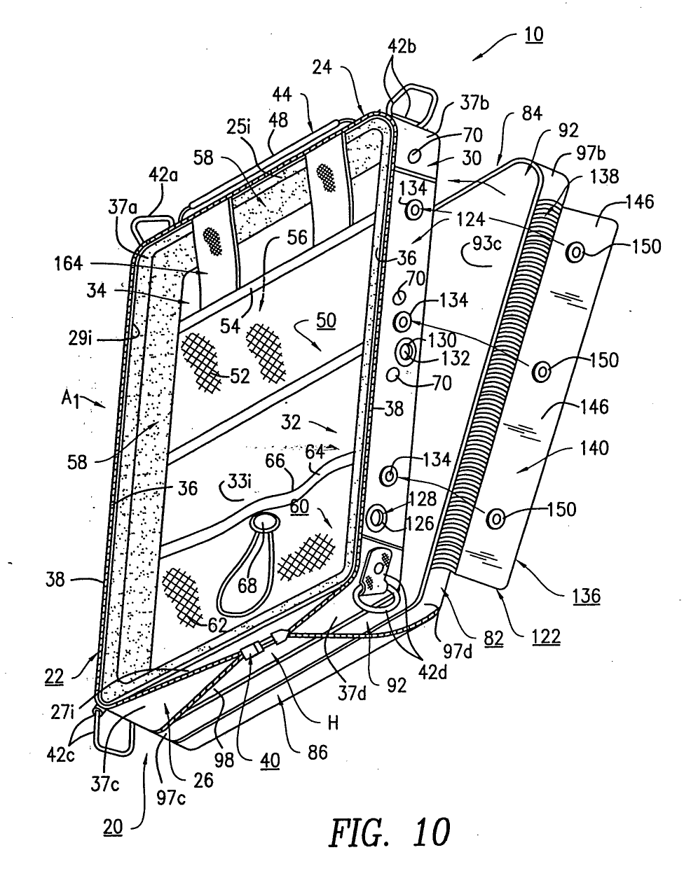

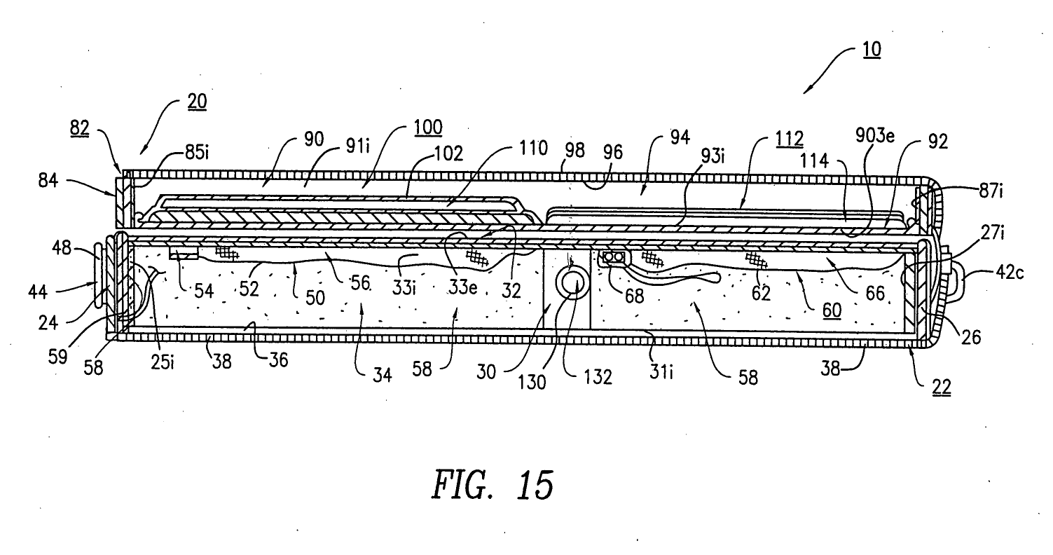

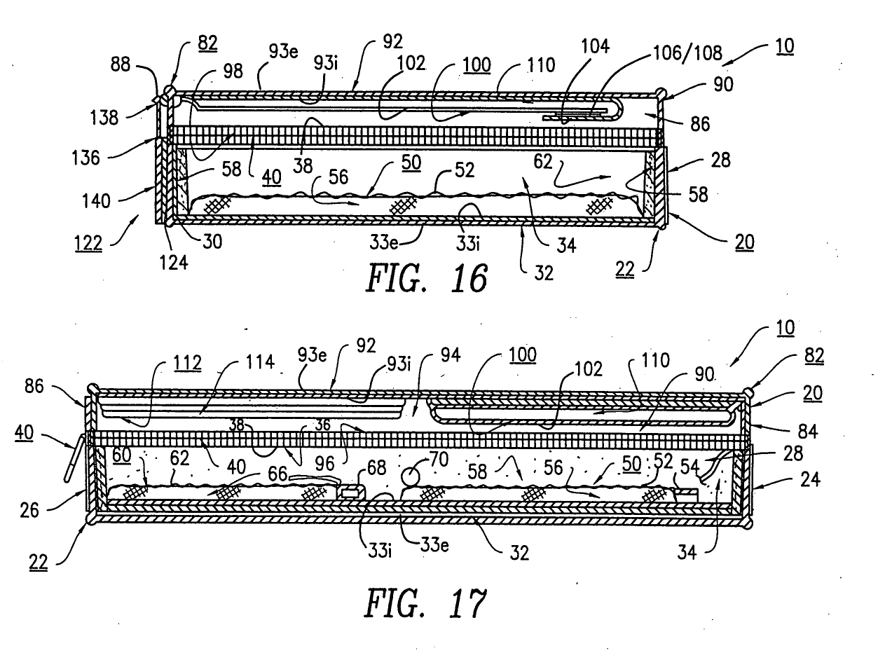

A digital video disc (DVD) player carrying case 10 for holding a portable DVD player 12 or other telecommunication devices therein and for attaching the DVD player carrying case 10 to a backside 13a or 13b and a headrest 14a or 14b of a front seat 15a or 15b, respectively, of a passenger vehicle 16 for viewing by passengers in rear seats (not shown) is represented in detail by FIGS. 1 through 17 of the patent drawings. As shown in FIGS. 1 to 3 and 5, the DVD player carrying case 10 includes a housing member 20 having a first inner storage compartment 22, a second inner storage compartment 82, a hinge assembly 122, and a harness strapping system 162 for attaching and holding the DVD player carrying case 10 to one of the front seats 15a or 15b of the passenger vehicle 16 in order for the rear seated passengers (not shown) to view the DVD player 12 in the passenger vehicle 16 while the vehicle 16 is in a stationary, parked or moving condition. The hinge assembly 122 includes a hinge attachment strip member 124 and a hinge attachment flap member 136. The harness strapping assembly 162 includes an upper headrest detachable attachment strap 164 and a lower backrest harness detachable strap 184.

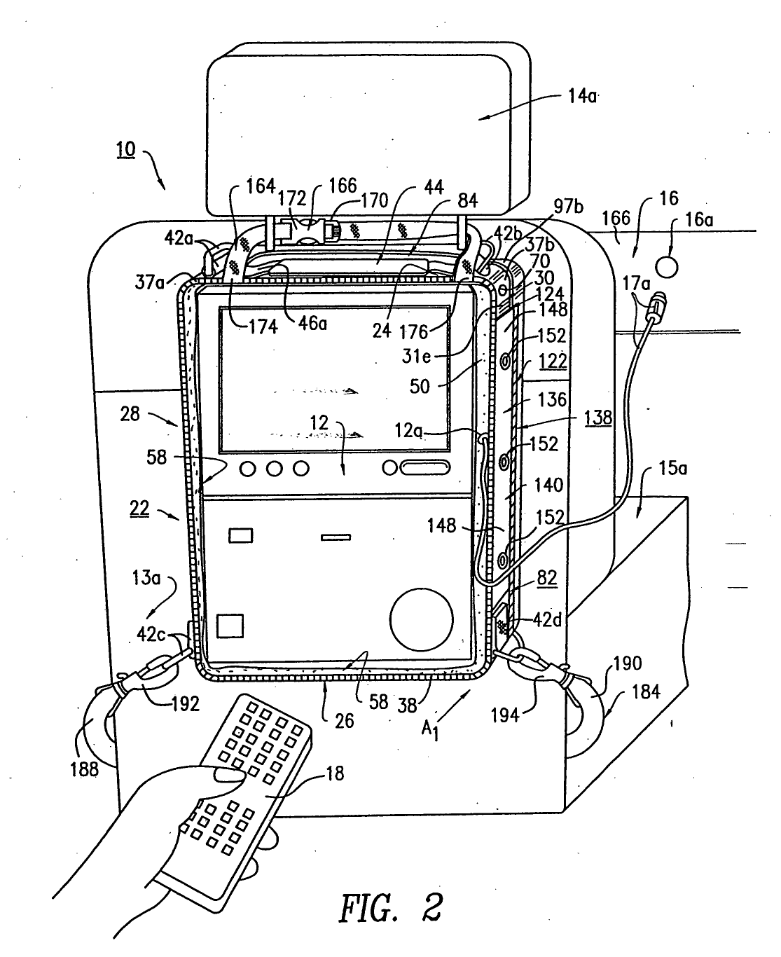

The detachable first inner storage compartment 22 of housing member 20, as depicted in FIGS. 1, 3, 6,9, 11, 14 and 15, includes a top wall 24, a bottom wall 26, a left side wall 28, a right side wall 30, and a rear wall 32 for forming a first interior storage space 34 for holding and storing of the DVD player 12 therein. The top wall 24 includes an interior wall surface 25i and an exterior wall surface 25e. The bottom wall 26 includes an interior wall surface 27i and an exterior wall surface 27e. The left side wall 28 includes an interior wall surface 29i and an exterior wall surface 29e. The right side wall 30 includes an interior wall surface 31i and an exterior wall surface 31e. The rear wall 32 includes an interior wall surface 33i and an exterior wall surface 33e. The detachable first inner storage compartment 22 also includes a first outer perimeter edging 36 having a first zipper element 38 of zipper member 40 attached thereto, as shown in FIGS. 1, 3, 6, and 8 of the drawings. The first outer perimeter edging 36 includes upper corners 37a and 37b and lower corners 37c and 37d, respectively. The upper corners 37a and 37b of the first outer perimeter edging 36 include upper attachment holding loop and ring members 42a and 42b, respectively, being attached to the top wall 24, as shown in FIGS. 2, 3 and 8 of the drawings. The lower corners 37c and 37d of the first outer perimeter edging 36 include lower attachment holding loop and ring members 42c and 42d, respectively, being attached to the bottom wall 26, as depicted in FIGS. 2, 3 and 11 of the drawings.

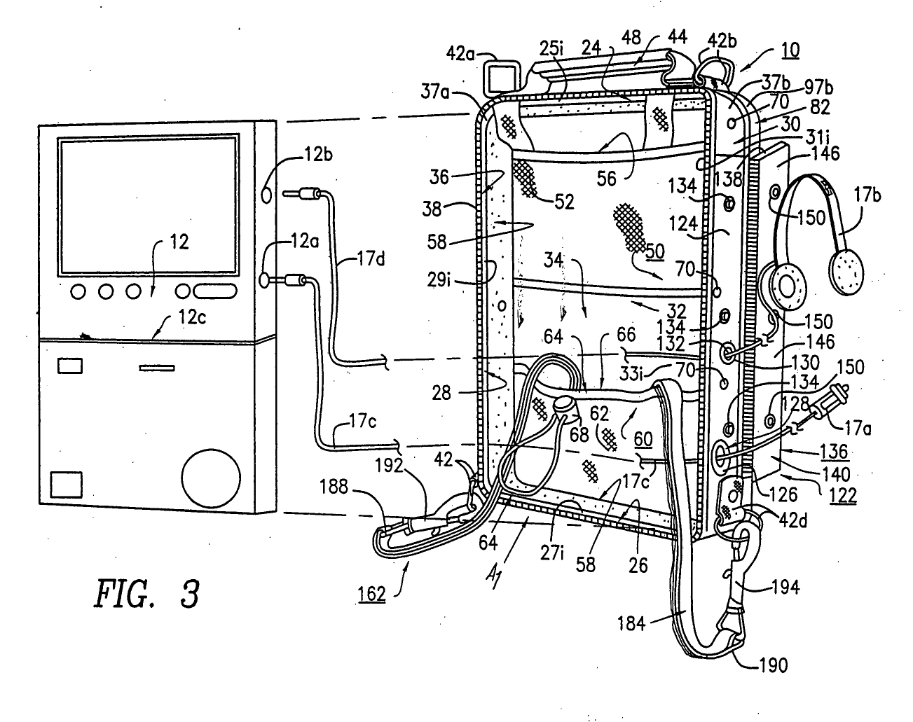

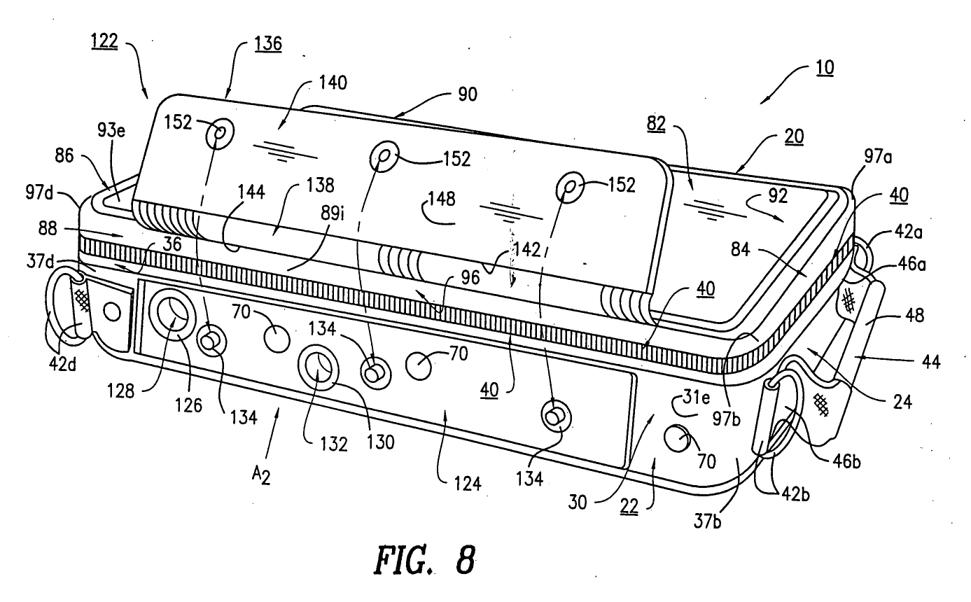

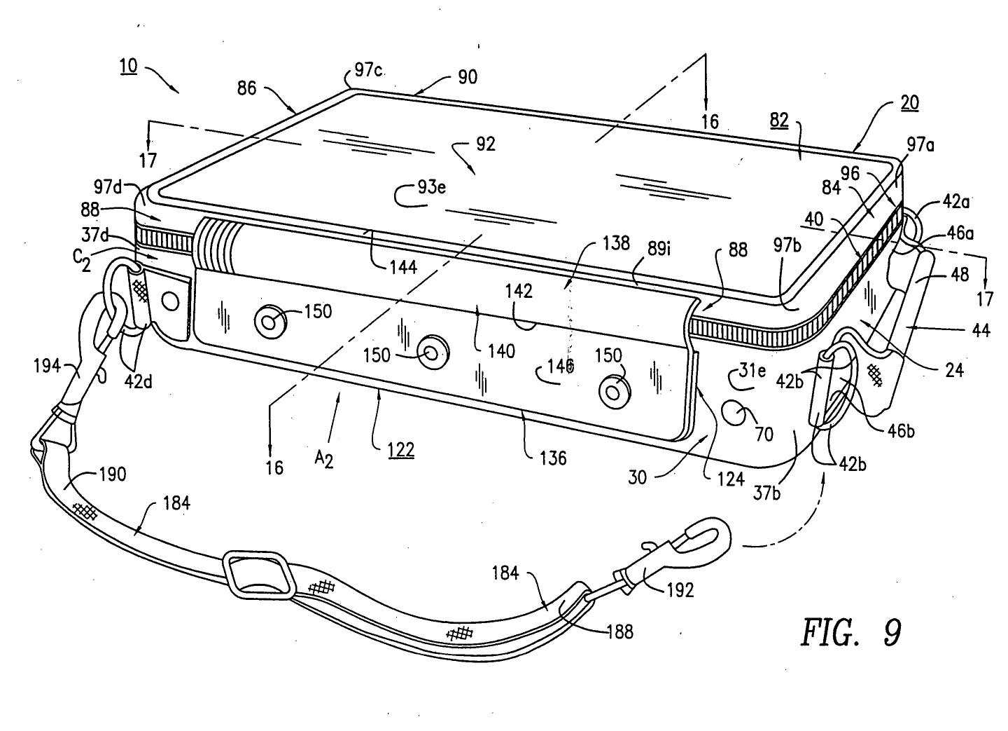

The top wall 24 of inner storage compartment 22, as shown in FIGS. 2 and 3, includes a handle strap member 44 having first and second ends 46a and 46b and having a center grasping section 48 thereon. The first and second ends 46a and 46b are fixedly attached to the upper corners 37a and 37b, respectively, of top wall 24. The handle strap member 44 is used for carrying the DVD player carrying case 10 to and from the passenger vehicle 16 when in a closed configuration C₂, as shown in FIGS. 8 and 9 of the drawings.

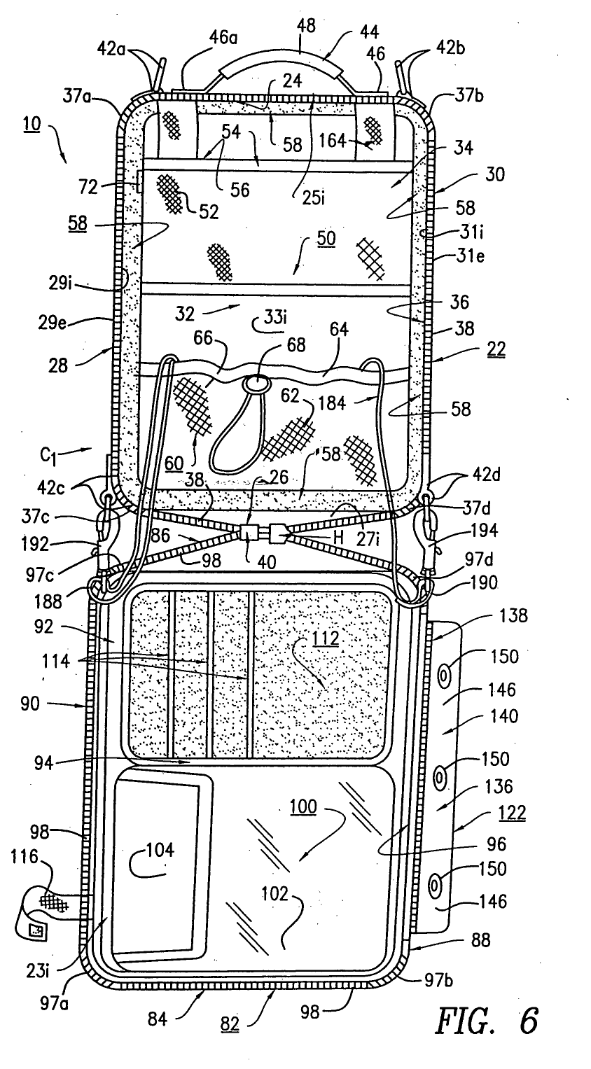

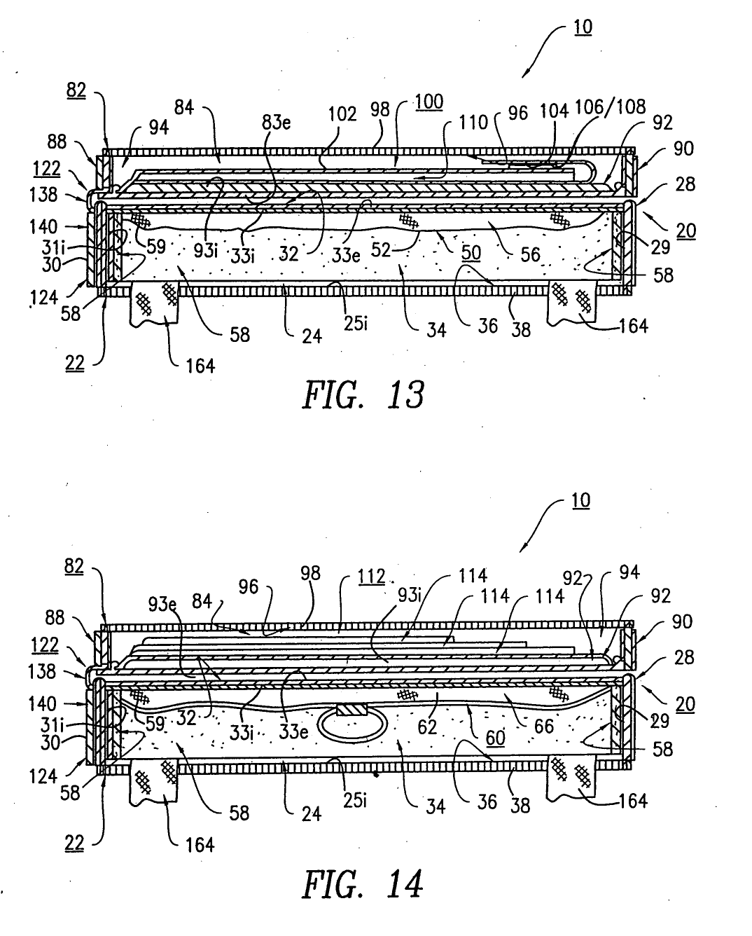

The interior wall surface 33i of rear wall 32 of the first inner storage compartment 22 includes an upper mesh inner storage pouch 50 having a mesh wall 52 with an elastic opening band 54 for closing the mesh wall 52 relative to the interior wall surface 33i of rear wall 32, as depicted in FIGS. 3, 6 and 13 to 15 of the drawings. The interior wall surface 33i, mesh wall 52 and elastic opening band 54 of the upper mesh inner storage pouch 50 are used to form an interior pouch receiving space 56 for holding of electronic accessories such as a removable extension cord and plug 17a and a headphone set 17b for attaching to the DVD player 12 when in use, as shown in FIGS. 3 and 6 of the drawings. The interior wall surface 33i of rear wall 32 also includes a lower mesh inner storage pouch 60 having a mesh wall 62 with an elastic closure band 64 for forming an interior pouch receiving space 66 for holding of a component part 184 of the harness strapping system 162 therein. The elastic closure band 64 has a button closure member 68 thereon for opening and closing the elastic closure band 64 of mesh wall 62 relative to the interior wall surface 33i of rear wall 32, as depicted in FIGS. 3 and 6 of the drawings. Additionally, the interior wall surfaces 25i, 27i, 29i and 31i of walls 24, 26, 28 and 30, respectively, include a perimeter cushioned interior wall 58 for holding, cushioning and securing of the DVD player unit 12 within the first interior storage space 34 of the first inner storage compartment 22, as shown in FIGS. 2, 3 and 13 to 15 of the drawings. As shown in FIGS. 13 to 17, the first inner storage compartment 22 further includes an inner perimeter support wall 59, being adjacent and in contact with the perimeter cushioned interior wall 58, for adding structural integrity to the first inner storage compartment 22. The inner perimeter support wall 59 is between the outer walls 24, 26, 28 and 30 and the perimeter cushioned interior wall 58, as shown in FIGS. 13 to 17 of the patent drawings.

As shown in FIGS. 3, 7, 8, 6 and 17, the exterior wall surface 3 le of the right side wall 30 of the first inner storage compartment 22 includes the fixedly connected hinge attachment strip member 124 being attached to the right side wall 30 by a plurality of rivet elements 70 thereto. The combined right side wall 30 and the hinge attachment strip member 124 includes a first grommet ring 126 having a first grommet hole opening 128 therethrough for receiving the extension cord and plug 17a of the DVD player unit 12, as depicted in FIG. 3. The combined right side wall 30 and the hinge attachment strip member 124 further includes a second grommet ring 130 having a second grommet hole opening 132 for receiving the extension wire and headphone set 17b therethrough, as shown in FIGS. 3 and 8 of the drawings. The combined right side wall 30 and the hinge attachment strip member 124 provides for additional structural integrity to the first inner storage compartment 22 of housing member 20. Additionally, the interior wall surface 29i of the left side wall 28 of first inner storage compartment 22 includes a hook fastening strip 72 thereon.

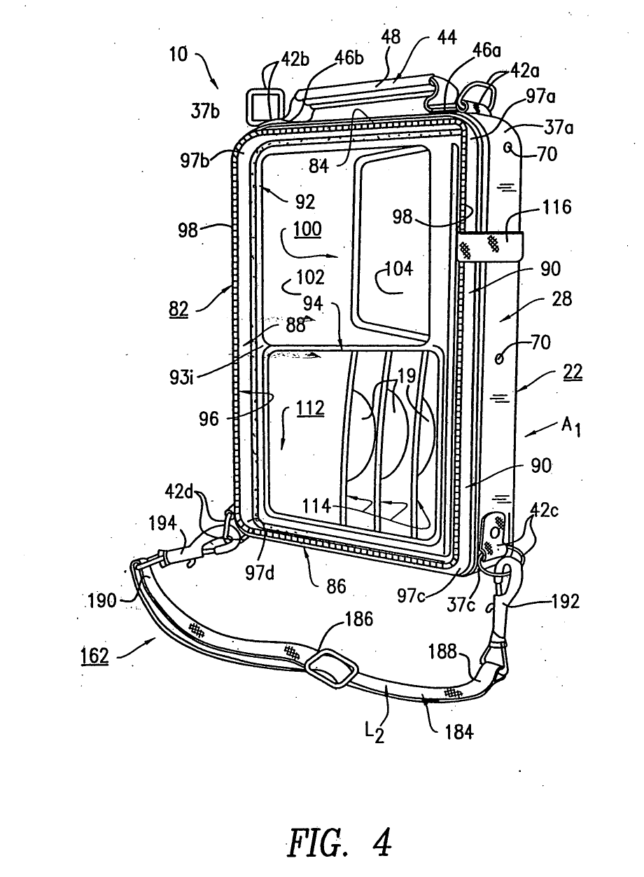

The detachable second inner storage compartment 82 of housing member 20, as depicted in FIGS. 4 to 6, 8, 10 and 13 to 15, includes a top wall 84, a bottom wall 86, a left side wall 88, a right side wall 90 and a rear wall 92 for forming a second interior storage space 94 therein. The left side wall 88 includes an interior wall surface 89i and an exterior wall surface 89e. The right side wall 90 includes an interior wall surface 91i and an exterior wall surface 91e. The rear wall 92 includes an interior wall surface 93i and an exterior wall surface 93e. The detachable second inner storage compartment 82 further includes a second outer perimeter edging 96 having a second zipper element 98 of zipper member 40 attached thereto, as shown in FIGS. 4, 6, 14 and 15 of the drawings. The second outer perimeter edging 96 include upper corners 97a and 97b and lower corners 97c and 97d, respectively.

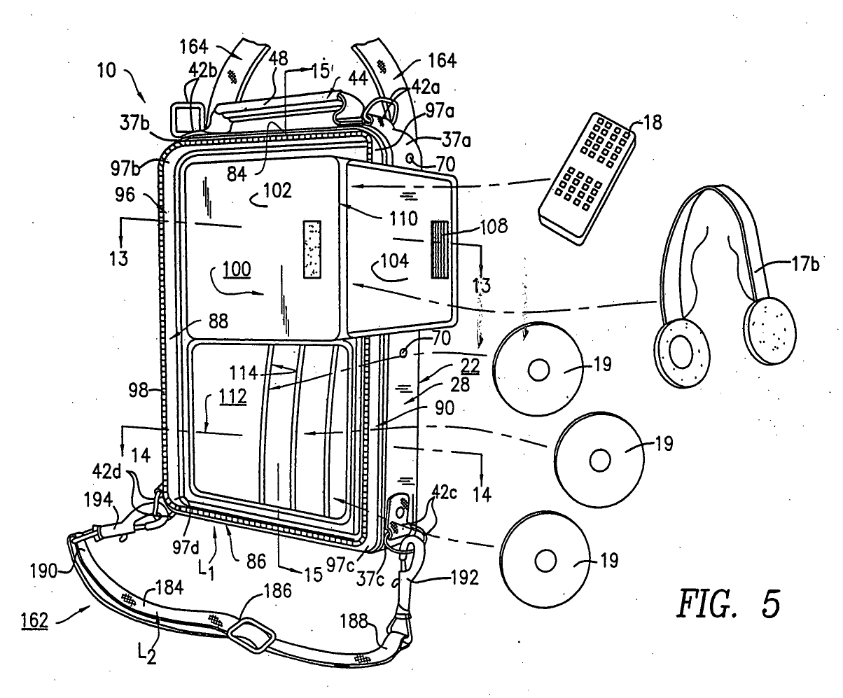

As shown in FIGS. 4, 6 and 7, the outer wall surface 93i of rear wall 92 of the second inner storage compartment 82 includes an upper inner storage pouch 100 having a pouch front wall 102 and a pouch closure flap 104. The pouch closure flap 104 and pouch front wall 102 include hook and loop strips 106 and 108, respectively, thereon for closing the pouch closure flap 104 relative to the pouch front wall 102 of the upper inner storage pouch 100, as depicted in FIGS. 4, 5 and 7 of the drawings. The interior wall surface 93i of wall 92 and the pouch front wall 102 of the upper inner storage pouch 100 are used to form an interior pouch receiving space 110 for receiving of a DVD remote control clicker 18 therein, as shown in FIG. 5 of the drawings. The interior wall surface 93i of rear wall 92 of the second inner storage compartment 82 also includes a lower inner DVD storage sleeve member 112 having a plurality of DVD sleeve receiving slots 114 for receiving one or more DVD recordings 19 therein.

The exterior wall surface 89e of the left side wall 88 of the second inner storage compartment 82, as shown in FIGS. 3, 7 and 8, includes the fixedly connected hinge attachment flap member 136 of hinge assembly 122. The interior wall surface 91i of the right side wall 90, as shown in FIGS. 4 and 6, includes a loop fastening strap 116 thereon for attaching to the hook fastening strip 72 in order to prevent the left side wall 28 of the first inner storage compartment 22 from separating with the right side wall 90 of the second inner storage compartment 82 when in assembled configuration A₁. As shown in FIGS. 6, 10 and 15, each of the bottom walls 26 and 86 of the first and second inner storage compartments 22 and 82, respectively, are aligned with each other and also hinged together at a connection point H via zipper member 40, when in a fully opened configuration C₁.

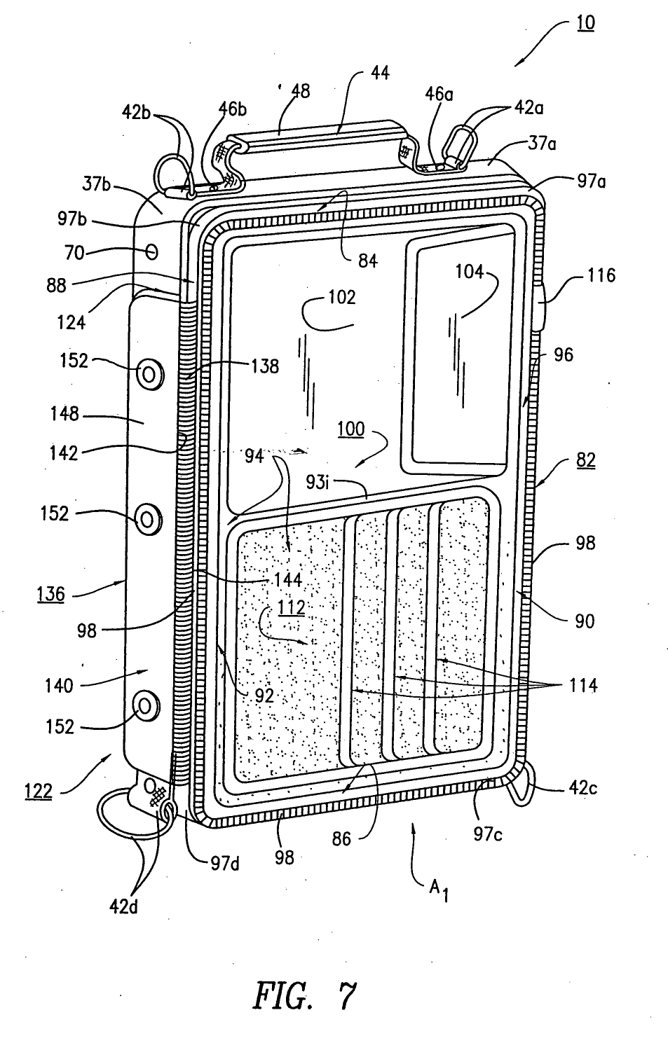

As shown in FIGS. 1, 3, 6, 8 and 10, the hinge assembly 122 includes a hinge attachment strip member 124 having a first grommet ring 126 with a first grommet hole opening 128 therethrough and having a second grommet ring 130 with a second grommet hole opening 132 therethrough. As previously indicated, the first and second grommet hole openings 128 and 132 are used for receiving the extension cord and plug 17a and the extension wire and headphone set 17b therethrough, respectively. The hinge attachment strip member 124 includes a plurality of male snap members 134 thereon. The hinge assembly 122 further includes a hinge attachment flap member 136 having a flexible attachment section 138 and a rigid attachment section 140 integrally connected thereto at a seam line 142, as shown in FIG. 8 of the drawings. The flexible attachment section 138 includes an inner perimeter edge 144 for attaching to the exterior wall surface 89i of the left side wall 88 and outer perimeter edging 96 of the second inner storage compartment 82, as depicted in FIGS. 8 and 9 of the drawings. Additionally, the rigid attachment section 140 of the hinge attachment flap member 136 includes an exterior wall surface 146 and an interior wall surface 148, as shown in FIGS. 8 and 9. The exterior wall surface 146 of the rigid attachment section 140 includes a first set of female snap members 150 thereon and the interior wall surface 148 of the rigid attachment section 140 includes a second set of female snap members 152 thereon. The second set of female snap members 152 on the interior wall surface 148 of rigid attachment section 140 of the second inner storage compartment 82 detachably connects to the male snap members 134 of the hinge attachment strip member 124 of the first inner storage compartment 22 when in an unassembled state A₂ and closed configuration C₁, as shown in FIG. 8 of the drawings. Conversely, the first set of female snap members 150 on the exterior wall surface 146 of rigid attachment section 140 of the second inner storage compartment 82 detachably connects to the male snap members 134 of the hinge attachment strip member 124 of the first inner storage compartment 22 when in the opened and assembled configuration A₁, as shown in FIGS. 1, 2, 7 and 14 of the drawings. The aforementioned assembled configuration A₁ interfaces and connects the first inner storage compartment 22 to the second inner storage compartment 82, as depicted in FIGS. 1, 2, 4, 7 and 10 of the drawings. It is understood that instead of the male snap members 134 and the female snap members 150 and 152, other types of fasteners may be used, such as hooks and loop fasteners (VELCRO™), metal clips, magnets, buttons or other suitable fastening means. As an additional connector, as previously described, the hook and loop fastening strip 72 and strap 116 of the first and second inner storage compartments 22 and 82, respectively, are connected together to further hold together the first and second inner storage compartments 22 and 82 when in the assembled and opened configuration A₁, as shown in FIGS. 4 and 7 of the drawings.

As shown in FIGS. 1, 3, 4 and 6, the harness strapping assembly 162 includes an upper headrest detachable strap 164 having a snap closure member 166 and an adjustable buckle member 168 attached hereto. The buckle member 168 is used for adjusting the length L₁ of the detachable strap 164 about the headrest 14a or 14b of front seat 15a or 15b of passenger vehicle 16 when in an operational and assembled configuration A₁. The snap closure member 166 includes a male insert prong 170 and a female receiving closure element 172 for undoing and removing or attaching the detachable strap 164 from the headrest 14a or 14b of front seat 15a or 15b when the DVD player carrying case 10 is not in use. The upper headrest detachable strap 164 further includes a first end 174 and a second end 176. The first end 174 of detachable strap 164 is fixedly connected to the left upper corner 37a and the second end 176 of detachable strap 164 is fixedly connected to the right upper corner 37b of the first inner storage compartment 22. The harness strapping assembly 162 further includes, as depicted in FIGS. 1, 3, 4, 6 and 12, a lower backrest harness detachable strap 184 having an adjustable buckle member 186 and having a first end 188 and a second end 190 thereto. The first and second ends 188 and 190 include first and second releasable latch members 192 and 194, respectively, thereon. The first and second releasable latch members 192 and 194 are detachably connected to the lower attachment holding loop and ring members 42c and 42d, respectively, of bottom wall 26 of the first inner storage compartment 22 for attaching and holding to the backside sections 13a or 13b of front seats 15a or 15b of passenger vehicle 16 when in an operational and assembled configuration A₁. The buckle member 186 is used for adjusting the length L₂ of the detachable strap 184 about the lower backside sections 13a or 13b of front seats 15a or 15b when in use. It is understood that the releasable latch members 192 and 194 of the detachable strap 184 can be used as a carrying shoulder strap 184 in conjunction with either upper and lower attachment holding loop and ring members 42a and 42d or 42b and 42d, respectively, when the housing member 20 of the DVD player carrying case 10 is in a closed configuration C₁, as shown in FIGS. 9 and 11 of the drawings.

The DVD player carrying case 10 can be made from materials such as leather, faux leather, flexible plastics, canvas and woven fabrics. The carrying case 10 can vary in size with regard to height, width and depth depending upon the size of the telecommunications apparatus being used by the operator of the passenger vehicle 16.

### OPERATION OF THE PRESENT INVENTION

In operating the DVD player carrying case 10 of the present invention the user proceeds in the following manner. The user initially carries the DVD player carrying case 10 and DVD player unit 12 within carrying case 10 by the handle strap 44 or by the carrying shoulder strap 184 to passenger vehicle 16. The user then proceeds to unzip the zipper member 40 about the first and second outer perimeter edgings 36 and 96 of the first and second inner outer storage compartments 22 and 82, respectively, of housing member 20, as depicted in FIGS. 3, 8, and 10 of the drawings. The next step is the user unsnaps the female snap members 152 on the interior wall surface 148 of hinge attachment flap member 136 from the male snap members 134 on the hinge attachment strip member 124 allowing the separation of the first inner storage compartment 22 from the second inner storage compartment 82, as shown in FIG. 8.

Next, the user pulls out the DVD player unit 12 from the first interior storage space 34 of the first inner storage compartment 22 in order to remove the various accessories from the carrying case 10. The user now removes the extension cord and plug 17a and the extension wire and headphone set 17b from the interior pouch receiving space 56 of the upper mesh storage pouch 50, as well as the upper headrest detachable strap 164 from the interior pouch receiving space 56 of the upper mesh storage pouch 50, as shown in FIGS. 3 and 6 of the drawings. Additionally, the user now removes the lower backrest harness detachable strap 184 from the interior pouch receiving space 66 of the lower mesh storage pouch 60. The user now proceeds to remove other accessories from the second inner storage compartment 82 of carrying case 10, wherein the user removes the DVD remote control clicker device 18 from the interior pouch receiving space 110 of the upper storage pouch 100, as depicted in FIG. 5 of the drawings. Further, the user now removes the DVD recordings(s) 19 from the DVD sleeve receiving slots 114 of the lower DVD storage sleeve member 112, as shown in FIG. 5. With the various accessories removed from the respective first and second inner storage compartments 22 and 82, the user now proceeds to interface the first inner storage compartment 22 with that of the second inner storage compartment 82, as depicted in FIGS. 3, 4 and 10 of the drawings.

The interfacing of the first and second inner storage compartments 22 and 82 proceeds in the following manner. The user connects the female snap members 150 on the exterior wall surface 146 of the hinge attachment flap member 136 with that of the male snap members 134 on hinge attachment strip member 124 of hinge assembly 122 such that each of the exterior rear walls 33e and 93e of rear walls 32 and 92 of the inner and outer storage compartments 22 and 82 are adjacent and in contact with each, respectively, as shown in FIGS. 3, 7 and 10 of the drawings. The user now connects the loop fastening strap 116 of the second inner storage compartment 82 with the hook fastening strip 72 of the first inner storage compartment 22, respectively, in order to connect and hold together the first and second inner storage compartments 22 and 82 when in the assembled and opened configuration A₁, as depicted in FIGS. 1, 4 and 7.

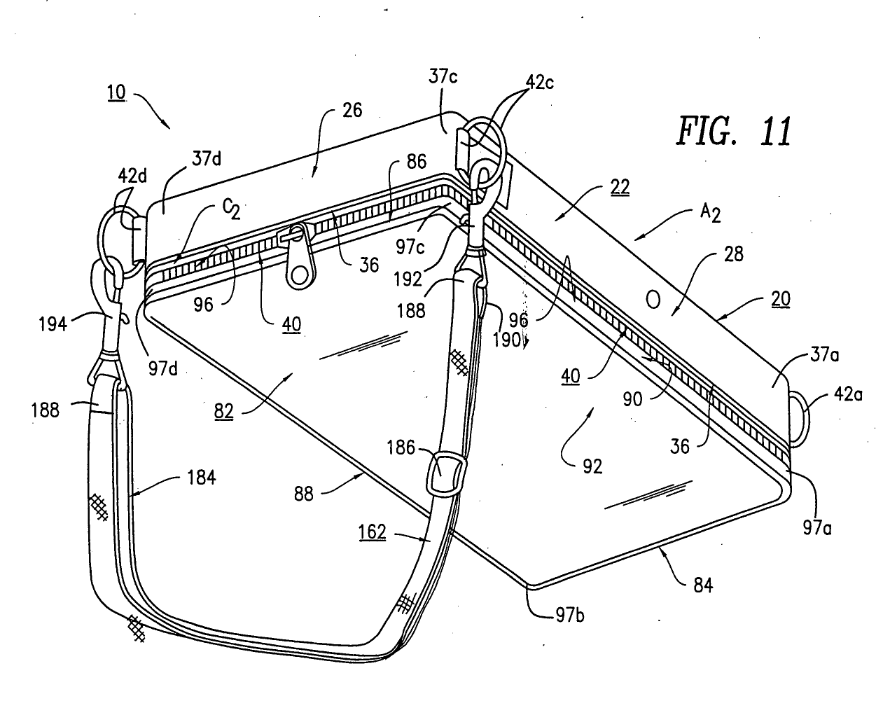

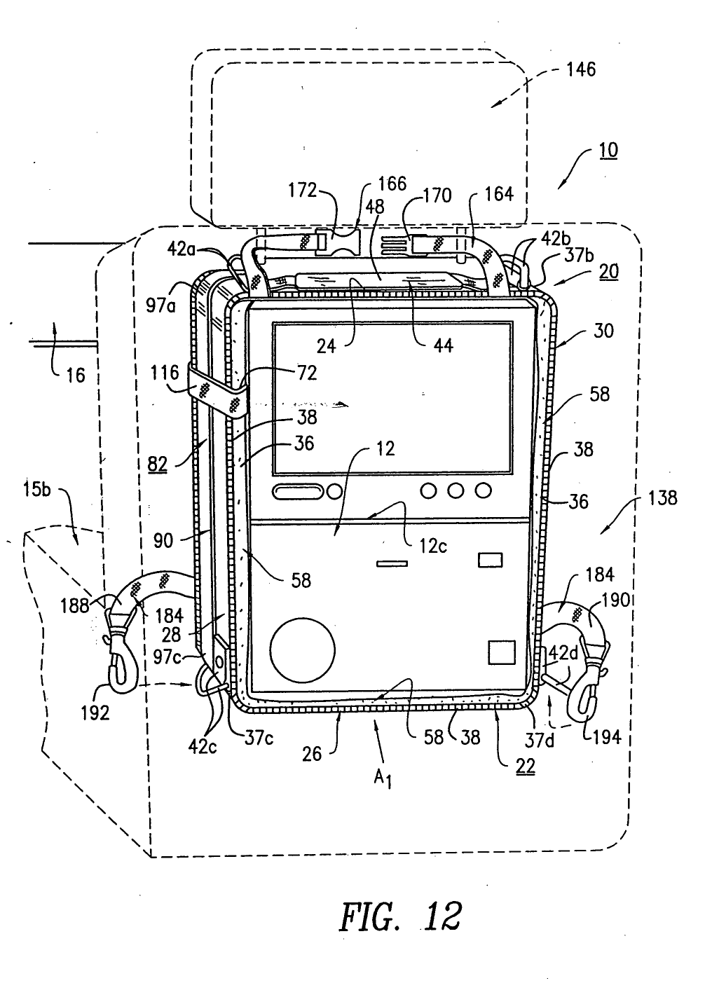

The user now adjusts the upper headrest detachable strap 164 via the adjustment buckle member 168 to a needed or required length L₁. In the next step, the user then inserts the male insert prong 170 into the female receiving closure element 172 to close the snap closure member 166 of detachable strap 164 about headrest 14a or 14b of front seat 15a or 15b of passenger vehicle 16, as shown in FIGS. 2 and 12 of the drawings. Next, the user adjusts the lower backrest harness detachable strap 184 via the adjustable buckle member 186 to a required length L₂, where then the user attaches the first releasable latch member 192 to the lower attachment holding loop and ring member 42c and places the remaining part of detachable strap 184 around the front seat 15a or 15b and attaches the second releasable latch member 194 to the lower attachment holding loop and ring member 42d. This placement puts the housing member 20 of carrying case 10 firmly on the backside section 13a or 13b of front seat 15a or 15b of passenger vehicle 16, as shown in FIGS. 2 and 12, such that the first inner storage compartment 22 is facing outwardly and the second inner storage compartment 82 is facing inwardly and is in connect and adjacent with the backside section 13a or 13b of front seats 15a or 15b of passenger vehicle 16.

The user now connects the extension cord and plug 17a into the vehicle power receptacle 16a on the dashboard 16b of passenger vehicle 16, and then the extension cord end 17c is put through the first grommet hole opening 128 of first grommet ring 126 and is ready to connect to the power inlet receptacle 12a of the DVD player unit 12. If needed, the extension wire end 17d of headphone set 17b is put through the second grommet hole opening 132 of second grommet ring 130 and is ready to connect to the audio inlet receptacle 12b of the DVD player unit 12. Next, the user places the DVD player unit 12 within the first interior storage space 34 of the first inner storage compartment 22, such that the perimeter cushioned interior wall 58 holds, secures and cushions the DVD player unit 12 thereto, as depicted in FIGS. 1 and 2 of the drawings. The user is now ready to insert the DVD recording 19 into the DVD inlet opening 12c of DVD player unit 12 for playing a predetermined movie, music video or instructional video and the like for viewing by the viewers in the rear seats (not shown) of passenger vehicle 16, as shown in FIG. 2 of the drawings.

### ADVANTAGES OF THE PRESENT INVENTION

Accordingly, an advantage of the present invention is that it provides for a DVD player carrying case that gives the user a unique and novel carrying and fastening system being especially designed for remotely transporting telecommunication equipment for portable use. In particular, the present invention provides for an apparatus for transport of such devices that include but are not limited to DVD devices, televisions (TVs), television video cassette recorder (VCR) units, combined TV and DVD units, computer monitors and equipment, and video telephones, etc. for use both separately or in combination with each other and with other peripheral and accessory equipment.

Another advantage of the present invention is that it provides for a DVD player carrying case for the transport of portable telecommunications equipment for use away from the home or office.

Another advantage of the present invention is that it provides for a DVD player carrying case being designed and constructed to protect, organize, fasten and strap the DVD unit during transportation and use.

Another advantage of the present invention is that it provides for a DVD player carrying case that is easily fastened and strapped to one of the front seats of a moving vehicle and firmly positioned and secured on the backside of one of the front seats of the vehicle in order to minimize vibration for viewing the DVD unit by passengers seated in the rear seats of the moving vehicle.

Another advantage of the present invention is that it provides for a DVD player carrying case that can be designed and configured for use in moving vehicles such as automobiles, jeeps, minivans, vans, sport utility vehicles, recreational vehicles, campers, limos, boats, recreational aircraft and the like.

Another advantage of the present invention is that it provides for a DVD player carrying case that enables the users to safely bring along such fragile telecommunication equipment (i.e, DVD monitors) for use in a variety of remote settings.

Another advantage of the present invention is that it provides for a DVD player carrying case that is of a two part construction having a first inner storage compartment and a second inner storage compartment interfaced with each other for increased internal and external structural support for housing of the DVD unit therein.

Another advantage of the present invention is that it provides for a DVD player carrying case that incorporates a unique and improved construction and design in terms of size, modularity, materials, water resistant integrity, internal and external structural support, remote power supply capability, user and equipment access, storage capacity, and design capability with the transportation medium such as a vehicle and/or platform configuration of the vehicle in order to overcome the problems posed by the prior art.

A further advantage of the present invention is that provides for a DVD player carrying case that is capable of withstanding everyday wear and tear, as well as being secure safe, efficient, durable and easy to use.

A still further advantage of the present invention is that it provides for DVD player carrying case that can be mass produced in automated and economical manner and is readily affordable by the consumer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirt and scope of the invention herein.

1. A carrying case for securing a telecommunication device to a seat within a vehicle, comprising:
a) a housing member including a first inner storage compartment and a second inner storage compartment;
b) said first inner storage compartment having walls for forming an interior storage space (34) for receiving and holding a telecommunication device therein;
c) said second inner storage compartment having walls for forming an interior storage space (94) therein;
d) connecting means for detachably connecting said first inner storage compartment and said second inner storage compartment and for receiving and displaying a telecommunication device in said first inner storage compartment;
e) a hinge assembly including a hinge attachment strip member and a hinge attachment flap member for detachably connecting said first inner storage compartment to said second inner storage compartment, said hinge attachment strip member being formed on a side wall of said first inner storage compartment;
f) said hinge attachment flap member of said hinge assembly being detachable from said hinge attachment strip member; and said hinge attachment flap member being reversible for moving said hinge attachment flap member from a first attachment position for having said housing member in a closed configuration to a second attachment position for having said housing member in an opened and assembled configuration;
g) a harness strapping assembly having a pair of detachable straps and strap connecting means for connecting to a seat of a vehicle; and
h) one of said detachable straps having at its outer ends means for releasably connecting to said strap connecting means of said first inner storage compartment.

2. A carrying case in accordance with claim 1, wherein said connecting means includes a zipper closure member for detachably connecting said first and second inner storage compartments with each other.

3. A carrying case in accordance with claim 2, wherein said first and second inner storage compartments include first and second outer perimeter edgings thereon, respectively.

4. A carrying case in accordance with claim 3, wherein each of said outer perimeter edgings include a zipper strip element thereon for forming said zipper closure member for closing said first and second inner storage compartments together.

5. A carrying case in accordance with claim 1, wherein said hinge attachment flap member includes a first surface and a second surface having first snap members on said first surface for attaching said flap member to hold said first inner storage compartment in said closed position and having second snap members on said second surface for attaching said flap member to hold said first inner storage compartment in said open position.

6. A carrying case in accordance with claim 1, wherein said walls of said first inner storage compartment includes a top wall, a bottom wall, side walls and a rear wall for forming said first inner storage compartment; and wherein said walls of said second inner storage compartment includes a top wall, a bottom wall, side walls and a rear wall for forming said second inner storage compartment.

7. A carrying case in accordance with claim 6, wherein a part of said rear wall (32) of said first inner storage compartment forms a first interior wall of a first inner storage pouch (50) having a front mesh wall for forming a first interior pouch storage space therein.

8. A carrying case in accordance with claim 6, wherein a part of said rear wall (32) of said first inner storage compartment forms a second interior wall of a second inner storage pouch (60) having a front mesh wall with closure means thereon for forming a second interior pouch storage space therein.

9. A carrying case in accordance with claim 6, wherein a part of said rear wall (92) of said second inner storage compartment forms an interior wall of an inner storage pouch (100) having a front wall with closure means thereon for forming an interior storage space therein.

10. A carrying case in accordance with claim 6, wherein a part of said rear wall (92) of said second inner storage compartment includes a disc sleeve member attached thereto for forming a plurality of sleeve receiving slots for holding recording discs therein.

11. A carrying case in accordance with claim 6, wherein said top wall (24) of said first inner storage compartment includes a pair of upper corners; each of said upper corners having an upper attachment holding loop and ring member thereon.

12. A carrying case in accordance with claim 6, wherein said bottom wall (26) of said first inner storage compartment includes a pair of lower corners; each of said lower corners having a lower attachment holding loop and ring member thereon for receiving said releasably attaching means on said outer ends of one of said detachable straps.

13. A carrying case in accordance with claim 1, wherein said top wall (24) of said first inner storage compartment includes a handle strap having a grasping section and having first and second ends thereto.

14. A carrying case in accordance with claim 13, wherein said first and second ends of said handle strap are fixedly connected to each of said upper corners of said top wall (24) of said first inner storage compartment.

15. A carrying case in accordance with claim 7, wherein said front mesh wall (52) includes an elastic opening band (54) for opening and closing said front mesh wall of said first interior pouch storage space relative to said first interior wall of said first inner storage pouch (50).

16. A carrying case in accordance with claim 8, wherein said closure means includes a button closure member for opening and closing said front mesh wall of said second interior storage space relative to said second interior wall of said second inner storage pouch.

17. A carrying case in accordance with claim 9, wherein said closure means includes a flap closure member for opening and closing said front wall of said interior storage space relative to said interior wall of said inner storage pouch.

18. A carrying case in accordance with claim 1, wherein said hinge attachment strip member of said hinge assembly is fixedly connected to one of said side walls by a plurality of connectors.

19. A carrying case in accordance with claim 5, wherein said hinge attachment strip member of said hinge assembly includes third snap members thereon.

20. A carrying case in accordance with claim 1, wherein said hinge attachment strip member includes a first grommet ring having a first grommet opening for receiving a extension cord and plug therethrough.

21. A carrying case in accordance with claim 1, wherein said hinge attachment strip member includes a second grommet ring having a second grommet hole opening for receiving an extension wire of a headphone set therethrough.

22. A carrying case in accordance with claim 1, wherein said hinge attachment strip member provides for additional structural integrity to said first inner storage compartment of said housing member.

23. A carrying case in accordance with claim 1, wherein said hinge attachment flap member of said hinge assembly includes a flexible attachment section and a rigid attachment section being connected to each other.

24. A carrying case in accordance with claim 23, wherein said flexible attachment section of said hinge attachment flap member includes a perimeter edge for attaching to said second inner storage compartment.

25. A carrying case in accordance with claim 19, wherein said second snap members on said hinge attachment flap member cooperatively connect to said third snap members on said hinge attachment strip member of said assembled hinge assembly in order to join together said first inner storage compartment to said second inner storage compartment for forming said assembled housing member.

26. A carrying case in accordance with claim 1, wherein said pair of detachable straps of said harness strapping system includes a first harness detachable strap for releasably holding and securing to a headrest of a front seat of a passenger vehicle and a second harness detachable strap for releasably holding and securing to a backrest section of a front seat of a passenger vehicle.

27. A carrying case in accordance with claim 26, wherein said first harness detachable strap includes an adjustable strap and includes an adjustable buckle member for changing the length of said first harness detachable strap in order to fit about the headrest of the front seat of the passenger vehicle.

28. A carrying case in accordance with claim 26, wherein said first harness detachable strap includes a buckle closure member having male and female elements thereon for releasably opening and closing said first harness detachable strap about the headrest of the front seat of the passenger vehicle.

29. A carrying case in accordance with claim 26, wherein said second harness detachable strap include first and second ends each having first and second releasable latch members, respectively, thereon.

30. A carrying case in accordance with claim 29, wherein said first and second releasable latch members are detachably connected to said lower attachment holding loop and ring members on said bottom wall (26) of said first inner storage compartment for releasably opening and closing said second harness detachable strap about the backrest section of the front seat of the passenger vehicle.

31. A carrying case in accordance with claim 26, wherein said second harness detachable strap includes an adjustable harness buckle member for changing the length of said second harness detachable strap in order fit around the backrest section of the front seat of the passenger vehicle.

32. A carrying case in accordance with claim 26, wherein said second harness detachable strap is used as a carrying shoulder strap such that said first and second releasable latch members are connected to said upper and lower attachment holding loop and ring members, respectively, when said housing member is in a closed configuration for carrying said carrying case to and from the passenger vehicle.

33. A carrying case in accordance with claim 1, wherein said first interior storage space of said first inner storage compartment includes an interior perimeter cushioned wall member for holding, securing and cushioning of the telecommunication device within said first interior storage space.

34. A carrying case in accordance with claim 33, wherein said interior perimeter cushioned wall member and said first interior storage space of said first inner storage compartment cooperate to receive a telecommunication device selected from a group consisting of DVD player units, televisions, combined TV and DVD units, television VCR units, computer monitors and equipment, video telephones and other telecommunication devices for use both separately or in combination with each other.

35. A carrying case in accordance with claim 1, wherein said housing member of said carrying case is made from flexible materials such as leather faux leather, polyesters, canvas, woven fabrics and combinations thereof.

36. A carrying case in accordance with claim 1, wherein said housing member is of a size and shape for storing of various telecommunication devices therein.
